(19) United States
(12) Patent Application Publication
(10) Pub. No.: US 2006/0217827 A1
(43) Pub. Date: Sep. 28, 2006

(54) SOUND PLAYER WITH A SEPARABLE MEMORY

(76) Inventors: Chin-Sung Hsu, Taipei City (TW); Ming-Shiang Chen, Taipei City (TW); Yu-Wen Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/307,218

(22) Filed: Jan. 27, 2006

(30) Foreign Application Priority Data
Feb. 4, 2005 (TW) 094103649

(51) Int. Cl. G06F 17/00

(52) U.S. Cl. 700/94; 369/69

(57) ABSTRACT

A sound player includes a first module including a first connector and a memory electrically connected to the first connector for storing digital audio data. The sound player further includes a second module including a controller for controlling the operation of the sound player, a flash memory electrically connected to the controller for storing digital audio data, a second connector electrically connected to the controller for connecting to the first connector in a detachable manner, a user interface operable to allow a user to input a signal to the controller for selecting digital audio data stored in the flash memory of the second module or for selecting digital audio data stored in the memory of the first module through the first connector and the second connector, a decoder for converting selected digital audio data into audio signals, and an audio output port for outputting the audio signals.

### BACKGROUND OF THE INVENTION

1. Field of the Invention

The present invention relates to a sound player, and more particularly, to a sound player with a separable memory.

2. Description of the Prior Art

With the advent of digital music being readily available, users have a new source of musical content. Digital music content resides in relatively small digital files that can be stored on portable non-volatile memory devices. Due to the popularity of digital music, portable music players such as Moving Pictures Expert Group, Layer 3 (MP3) players, as well as other types of music players can be found everywhere.

Generally there are two kinds of MP3 players, classified according to the format of the memory used for storing music data. One utilizes flash memory, and the other utilizes hard disks. The MP3 player with the flash memory is popular for its small size and its light weight. However, the MP3 player with the flash memory has a fixed amount of memory available for storing digital music. As an example, suppose that the flash memory has a capacity of 64 MB, which can store about one hour of digital music in the MP3 format. If the user wishes to go on an extended trip, he will quickly run out of new songs to listen to on the MP3 player due to the small capacity of the flash memory. In order to overcome these problems, the user must buy multiple MP3 players. Unfortunately, having more than one MP3 player greatly increases the cost associated with enjoying digital music. To overcome the drawback of memory capacity of the MP3 player with the flash memory, the MP3 player with the hard disk is designed for enlarging the amount of memory for storing digital music data. However, an MP3 player with a hard disk has the disadvantages of having a heavy weight, consuming more electricity, and being fragile. Hence there is a need to combine the advantages of the two MP3 players for providing users with a better portable music player.

### SUMMARY OF THE INVENTION

It is therefore a primary objective of the claimed invention to provide a sound player with a separable memory.

According to the claimed invention, a sound player includes a first module, a first connector, and a memory electrically connected to the first connector for storing digital audio data. The sound player further includes a second module, a controller for controlling the operation of the sound player, a flash memory electrically connected to the controller for storing digital audio data, a second connector electrically connected to the controller for connecting to the first connector in a detachable manner, a user interface to input a signal to the controller for selecting digital audio data stored in the flash memory of the second module or for selecting digital audio data stored in the memory of the first module through the first connector and the second connector, a decoder for converting selected digital audio data into audio signals, and an audio output port for outputting the audio signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a drawing of a sound player according to the present invention.

FIG. 2 is a functional block diagram of the sound player in FIG. 1 according to the present invention.

### DETAILED DESCRIPTION

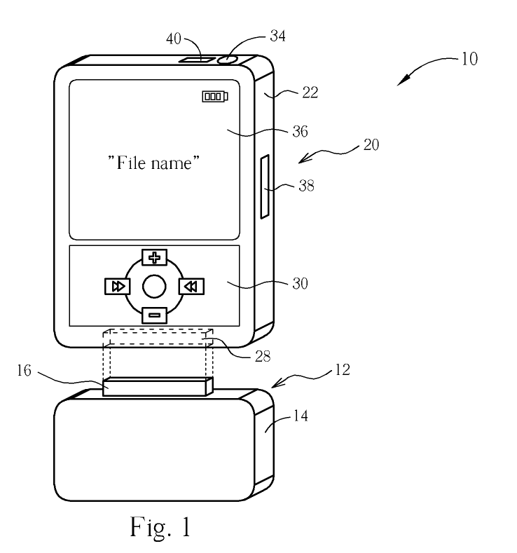

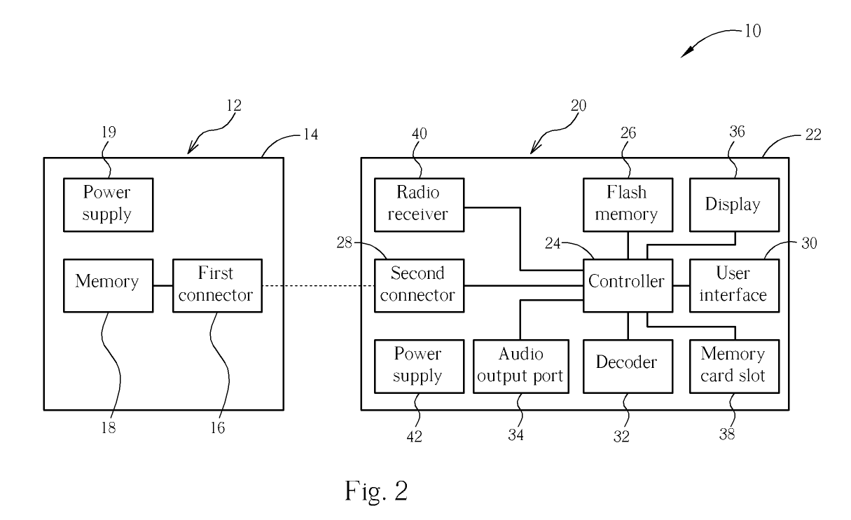

Please refer to FIG. 1 and FIG. 2 FIG. 1 is a drawing of a sound player 10 according to the embodiment of the present invention, and FIG. 2 is a functional block diagram of the sound player 10 according to the embodiment of the present invention. The sound player 10 can be an MP3 player. The sound player 10 includes a first module 12 and a second module 20. The first module 12 includes a first housing 14, a first connector 16, a memory 18, and a power supply 19. The second module 20 includes a second housing 22, a controller 24, a flash memory 26, a second connector 28, a user interface 30, a decoder 32, an audio output port 34, a display 36, a memory card slot 38, a radio receiver 40, and a power supply 42.

The first connector 16 of the first module 12 is installed on the first housing 14. The memory 18 is installed inside the first housing 14 and electrically connected to the first connector 16 for storing digital audio data. The memory can be a hard disk having an IDE interface or a USB interface. The power supply 19 supplies power to the first module 12 and can be a battery.

The controller 24 is installed inside the second housing 22 for controlling the operation of the sound player 10. The flash memory 26 can be a NAND flash memory and is installed inside the second housing 22 and electrically connected to the controller 24 for storing digital audio data. The second connector 28 is installed on the second housing 22 and electrically connected to the controller 24 for connecting to the first connector 16 in a detachable manner. The user interface 30 is electrically connected to the controller 24 and operable to allow a user to input a signal to the controller 24 for selecting digital audio data stored in the flash memory 26 of the second module 20 or for selecting digital audio data stored in the memory 18 of the first module 12 through the first connector 16 and the second connector 28. The decoder 32 is installed inside the second housing 22 and capable of converting the digital audio data selected by the user interface 30 into audio signals. For example, the decoder 32 can be an MP3 decoder for converting the digital audio data of MP3 format into audio signals or can convert the digital audio data of WMA format into audio signals. The audio output port 34 is capable of outputting the audio signals converted by the decoder 32. The audio output port 34 can be an earphone or a speaker operable to allow a user to listen to the sound played by the sound player 10. The display 36 is capable of displaying an operation status of the sound player 10, such as the selected music files, the selected broadcaster, or the capacity of the battery. The display 36 can be a liquid crystal display (LCD). The memory card slot 38 is capable of reading data of a memory card. The radio receiver 40 is capable of receiving radio signals, such as FM or AM radio signals, and is capable of outputting audio signals corresponding to the radio signals to the audio output port 34. The power supply 42 is capable of providing the electricity to the second module 20. The power supply 42 can be a battery or can receive the electricity from an external power supply. In addition, the power supply 19 of the first module 12 can receive the electricity from the power supply 42 of the second module 20 for providing the electricity to the first module 12.

The characteristic of the present invention is that the sound player 10 includes the two parts, the first module 12 and the second module 20. The data transmission between the first module 12 and the second module 20 is through the connection of the first connector 16 and the second connector 28. The first connector 16 and the second connector 28 can use the USB interface, such as USB 1.0, USB 2.0, or USB OTG, the IEEE 1394 interface, or the IDE interface. If the first connector 16 is a USB connector and the memory 18 of the first module 12 is a hard disk of the IDE interface, the first module 12 can further include a USB/IDE interface converter for converting data between the USB interface and the IDE interface. As shown in FIG. 1, the first connector 16 is a male connector and the second connector 28 is a female connector. The connection between the first connector 16 and the second connector 28 can also use other types and standards besides the ones mentioned above. When the first module 12 and the second module 20 are connected through the connection of the first connector 16 and the second connector 28, the user can select the digital audio data stored in the flash memory 26 of the second module 20 or the digital audio data stored in the memory 18 of the first module 12 through the connection of the first connector 16 and the second connector 28 by the user interface 30. Therefore, the total capacity for storing digital audio data in the sound player 10 is the sum of the capacity of the flash memory 26 and the capacity of the memory 18. The combination of the first module 12 and the second module 20 is similar to an MP3 player with a hard disk in the prior art. The first module 12 is similar to an external hard disk for connecting to a computer to download digital audio data to the memory 18 of the first module 12. After downloading digital audio data from the computer and storing digital audio data to the memory 18 of the first module 12, the first module 12 can be disconnected from the computer and be connected to the second module 20. After the controller 24 of the second module 20 detects the connection of the first connector 16 and the second connector 28, the first module 12 can be regarded as a slave device. And then the user interface 30 is operable to allow the user to select the digital audio data stored in the flash memory 26 of the second module 20 or the digital audio data stored in the memory 18 of the first module 12 through the connection of the first connector 16 and the second connector 28. The user also can backup the digital audio data stored in the memory 18 of the first module 12 to the flash memory 26. If the user wants to take the sound player 10 outside for a long time, like going on a trip, the first module 12 can be connected to the second module 20 for storing more digital audio data.

When the first module 12 is disconnected from the second module 20 of the sound player 10, the controller 24 will detect the disconnection of the first connector 16 and the second connector 28. And then the user interface 30 is operable to allow the user to select the digital audio data stored in the flash memory 26 of the second module 20. The second module 20 which is stand-alone is similar to an MP3 player with a flash memory in the prior art and is light, portable, and electricity-saving. The second module 20 is capable of reading data stored in an external memory card through the memory card slot 38 so as to be a card reader. The source of the digital audio data stored in the flash memory 26 of the second module 20 can be from the memory 18 of the first module 12 through the connection of the first connector 16 and the second connector 28, or from the external memory card through the memory card slot 38. If the user has no need to listen a large number of digital audio data ordinarily, the second module 20 can function as a stand-alone MP3 player and have the advantages of being light, portable, and electricity-saving.

In contrast to the conventional MP3 player, the sound player according to the present invention combines the advantages of the MP3 players with a flash memory and those with a hard disk. If the user wants to take the sound player 10 outside for a long time, such as when going on a trip, the first module can be connected to the second module for storing a large number of digital audio data. If the user has no need to listen a large number of digital audio data ordinarily, the second module can be a stand-alone MP3 player for being light, portable, and electricity-saving.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sound player comprising:
a first module comprising:
a first connector; and
a memory installed electrically connected to the first connector for storing digital audio data; and
a second module comprising:
a controller for controlling the operation of the sound player;
a flash memory electrically connected to the controller for storing digital audio data;
a second connector electrically connected to the controller for connecting to the first connector in a detachable manner;
a user interface electrically connected to the controller to input a signal to the controller for selecting digital audio data stored in the flash memory of the second module or for selecting digital audio data stored in the memory of the first module through the first connector and the second connector;
a decoder for converting the digital audio data selected by the user interface into audio signals; and
an audio output port for outputting the audio signals converted by the decoder.

2. The sound player of claim 1 wherein the first connector and the second connector utilize a USB interface, IEEE 1394 interface, or IDE interface.

3. The sound player of claim 1 wherein the memory of the first module is a hard disk.

4. The sound player of claim 3 wherein the memory of the first module is a hard disk having a USB interface.

5. The sound player of claim 1 wherein the flash memory of the second module is a NAND flash memory.

6. The sound player of claim 1 wherein the decoder of the second module is an MP3 decoder.

7. The sound player of claim 1 wherein the audio output port of the second module is an earphone jack.

8. The sound player of claim 1 wherein the second module further comprises a display for displaying an operation status of the sound player.

9. The sound player of claim 1 wherein the second module further comprises a memory card slot for reading data of a memory card.

10. The sound player of claim 1 wherein the second module further comprises a radio receiver for receiving radio signals and outputting audio signals corresponding to the radio signals to the audio output port.

11. The sound player of claim 1 wherein the first module further comprises a first housing, the first connector is installed on the first housing, and the memory is installed inside the first housing.

12. The sound player of claim 1 wherein the second module further comprises a second housing, the second connector is installed on the second housing, and the controller, the flash memory, the decoder are installed inside the second housing.
